(19) United States
(12) Patent Application Publication
(10) Pub. No.: US 2013/0239758 A1
(43) Pub. Date: Sep. 19, 2013

(54) OPEN WRENCH

(71) Applicants: CHUN-WEI YANG, Hang zhou (CN); ZHE-PING ZHANG, Long you Township (CN)

(72) Inventors: CHUN-WEI YANG, Hang zhou (CN); ZHE-PING ZHANG, Long you Township (CN)

(73) Assignees: ZHE JIANG YIYANG TOOL MANUFACTURE CO.,LTD, Long you xiao nan hai (CN); CHUN-WEI YANG, Hang zhou (CN)

(21) Appl. No.: 13/423,299

(22) Filed: Mar. 19, 2012

(51) Int. Cl. B25B 13/46

(52) U.S. Cl. 81/179

(57) ABSTRACT

An open wrench includes an elongate body with a head located on an end of the body. The head includes two jaws and a mounting hole is defined between the two jaws. One of the jaws has a curved recess, a curved guide slot and a notch defined in the inside thereof. The other jaw has a curved convex contact face protruding from the inside thereof. An engaging member is movably located in the curved guide slot and a resilient member biases the engaging member which performs as a ratchet wrench. Two covers are respectively connected to the top and the bottom of the head to cover up the engaging member and the resilient member.

### FIELD OF THE INVENTION

The present invention relates to an open wrench, and more particularly, to an open wrench with ratchet function.

### BACKGROUND OF THE INVENTION

The conventional open wrench with ratchet function is disclosed in U.S. Pat. No. 1,320,668 and generally includes a head with two jaws. One jaw has a curved guide slot defined in the inside thereof and the curved guide slot has a closed top or closed bottom. An engaging member is movably received in the guide slot. The other jaw has a through hole in which a spring is located. The shaping has one end biasing the engaging member so that the engaging member is movable and performs as a ratchet wrench. The head has a curved outer surface so that it is difficult to drill the through hole for receiving the spring because the drill tends to shift when drilling. Besides, the through hole is exposed on the outside of the head and affects the aesthetic appearance of the wrench.

U.S. Pat. No. 7,827,887 discloses an open wrench and includes a head with two jaws. One jaw has a curved guide slot defined in the inside thereof and the curved guide slot has a closed top and a closed bottom. A spring and a movable engaging member are received in the guide slot. The spring biases the engaging member so that the engaging member is movable and performs as a ratchet wrench. The engaging member has a guide rod extending therethrough and the spring is located in a notch defined in the inside of the guide slot. However, the guide slot with the enclosed top and bottom is difficult to be machined and the engaging member has less structure strength due to the guide rod extending through the engaging member. The open wrench provides one side of the engaging member and one jaw to clamp the two opposite sides of a hexagonal object lacks sufficient contact area to apply sufficient torque to the object. The two opposite sides of the hexagonal object are located at a distance from the axis of the hexagonal object so that the torque cannot be properly applied to the hexagonal object. The corner of the hexagonal object tends to impact the engaging member to cause wearing.

The present invention intends to provide an open wrench which is easily machined and manufactured, and performs as a ratchet wrench.

### SUMMARY OF THE INVENTION

The present invention relates to an open wrench and comprises an elongate body with a head located on an end of the body. The head includes two jaws and a mounting hole is defined between the two jaws. One of the jaws has a curved recess, a curved guide slot and a notch defined in the inside thereof. The other jaw has a curved convex contact face protruding from the inside thereof. An engaging member is movably located in the curved guide slot and a resilient member biases the engaging member which performs as a ratchet wrench. Two covers are respectively connected to the top and the bottom of the head to cover up the engaging member and the resilient member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the open wrench of the present invention;

FIG. 2 is a top view of the open wrench of the present invention;

FIG. 3 is a top view of the engaging member of the open wrench of the present invention;

FIG. 4 is a top view to show that the open wrench of the present invention is mounted to an object;

FIG. 5 shows the first action position of the open wrench of the present invention relative to the object;

FIG. 6 shows the second action position of the open wrench of the present invention relative to the object;

FIG. 7 shows the third action position of the open wrench of the present invention relative to the object;

FIG. 8 is an exploded view to show the second embodiment of the open wrench of the present invention;

FIG. 9 is a top view of the third embodiment of the open wrench of the present invention, and

FIG. 10 is an exploded view to show the fourth embodiment of the open wrench of the present invention.

### DETAILED DESCRIPTION OF THE PREFERRED EMBODIMENT

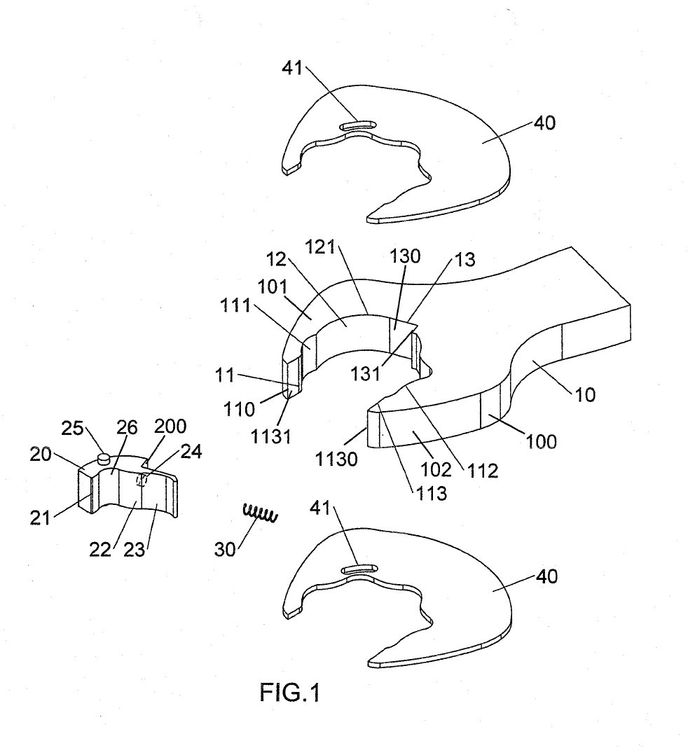

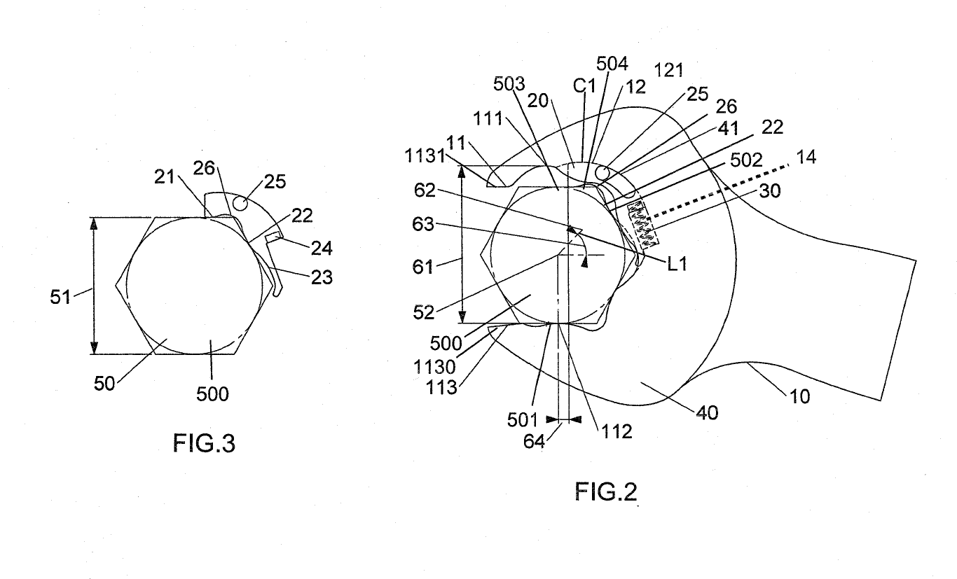

Referring to FIGS. 1 to 3, the open wrench of the present invention comprises an elongate body 10, an engaging member 20, a resilient member 30 and at least one cover 40.

Referring to FIGS. 1 to 3, the body 10 has a head 100 located on an end thereof and the head 100 has two jaws 101, 102. A mounting hole 11 is defined between the two jaws 101, 102 and an opening 113 is defined between two distal ends of the two jaws 101, 102 and the opening 113 communicates with the mounting hole 11. The axis of the mounting hole 11 is perpendicular to the axis of the body 10. The jaw 101 has a curved recess 111, a curved guide slot 12 and a notch 13 defined in the inside thereof. The curved recess 111, the curved guide slot 12 and the notch 13 open toward the direction of the axis of the mounting hole 11. The other jaw 102 has a curved convex contact face 112 protruding from the inside thereof. The opening 113 is located between two flat insides 1130, 1131 which extend outwardly to form a gradually enlarged opening. The curved guide slot 12 has a first curved face 121 defined in the inside thereof. The notch 13 has a first side 130 which has the first end connected with and tangential to an end of the first curved face 121. The second end of the first side 130 is bent to be a second side 131. The head 100 is cut to have the two jaws 101, 102 with the mounting hole 11, the curved recess 111, the contact face 112, the opening 113, the curved guide slot 12 and the notch 13 by way of laser cutting or linear cutting.

Referring to FIGS. 1 to 3, the engaging member 20 is movably received in the curved guide slot 12 and movable along the first curved face 121. The engaging member 20 has a first engaging portion 21 and a second engaging portion 22 which is connected to the first engaging portion 21 at an angle. The first and second engaging portions 21, 22 are two curved and convex portions. The engaging member 20 has an end face 200 located corresponding to the second side 131 and the end face 200 has a recess 24. A restriction portion 23 extends from one side of the end face 200 and is located corresponding to the first side 130. The end face 200, the first side 130, the second side 131 and the restriction portion 23 define a space 14. The engaging member 20 has a protrusion 25 which is parallel with the axis of the mounting hole 11. An arc recessed area 26 is defined at the conjunction area between the two engaging portions 21, 22.

Referring to FIGS. 1 to 3, when a hexagonal head 500 of an object 50 is clamped in the mounting hole 11, the diameter of the first curved face 121 is equal to or smaller than the shortest distance 51 of two opposite sides of the hexagonal head 500. The contact face 112 and one flat inside 1130 of the opening 113 are in contact with one side 501 of the hexagonal head 500. The contact face 112 is tangential to the center of the side 501. The two engaging portions 21, 22 respectively contact another two opposite sides 502, 503 of the hexagonal head 500. A corner 504 of the hexagonal head 500 is received in a recessed area 26 between the two engaging portions 21, 22. The longest distance 61 between the curved recess 111 and the contact face 112 is larger than the distance between two diagonal corners of the hexagonal head 500. The first curved face 121 is located on a circle C1 and a center 62 of the circle C1 is located within the mounting hole 11. An angle 63 is defined between a shortest distance L1 between the center 62 and the axis 52 of the hexagonal head 500 and the side 501 of the hexagonal head 500. The angle 63 is about 35 to 50 degrees.

Referring to FIG. 3, the resilient member 30 is located in the space 14 and one end of the resilient member 30 contacts the guide slot 12 and the other end of the resilient member 30 is engaged with the recess 24 to bias the engaging member 20.

Referring to FIGS. 1 and 3, two covers 40 each has the same shape as that of the head 100 and are mounted to top and bottom of the head 100 to seal the engaging member 20 and the resilient member 30 in the space 14. Each cover 40 has a curved slot 41 which shares a common axis 62 with the first curved face 121. The protrusion 25 extends through the curved slot 41 so as to guide the movement of the protrusion 25. The covers 40 are welded to the head 100 and the seams are flattened and polished to have smooth surface. The cover 40 is cut to have the curved slot 41 by way of laser cutting or linear cutting. The way of weld is melt welding, press welding, laser welding, argon welding, carbon dioxide electric welding, electric liquid arc welding, arc welding, air welding or electric resistance welding.

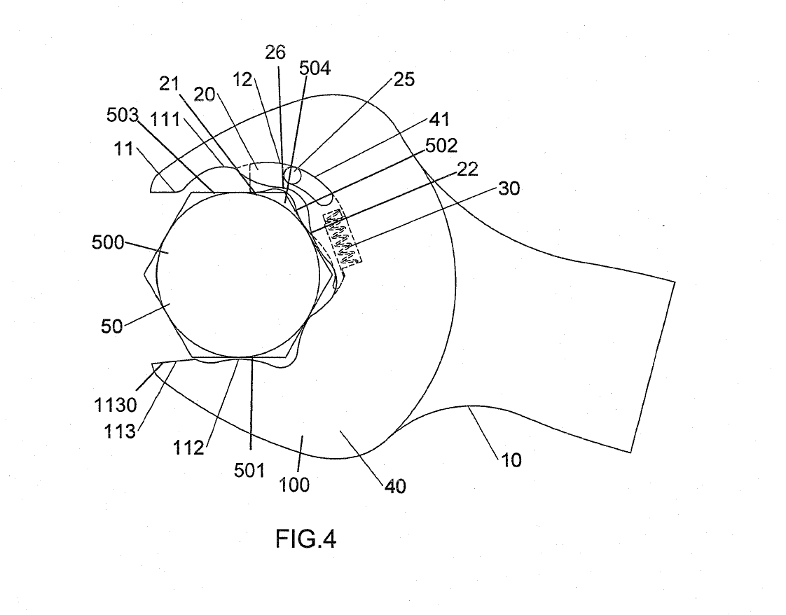

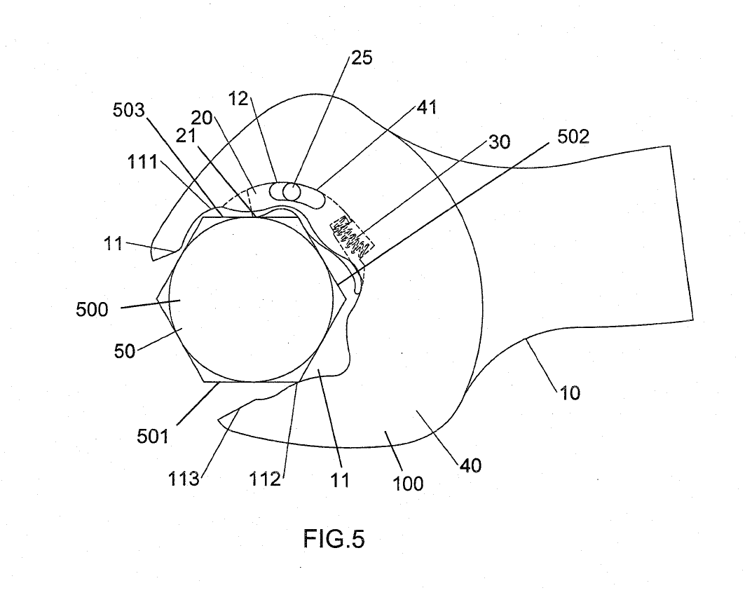

As shown in FIG. 4, the hexagonal head 500 of the object 50 is clamped by the open wench and the engaging member 20 is biased by the resilient member 30, the first and second engaging portions 21, 22 are in contact with two adjacent sides 502, 503 of the hexagonal head 500. The contact face 112 contacts another side 501 of the hexagonal head 500. The body 10 is rotated clockwise to rotate the object 50.

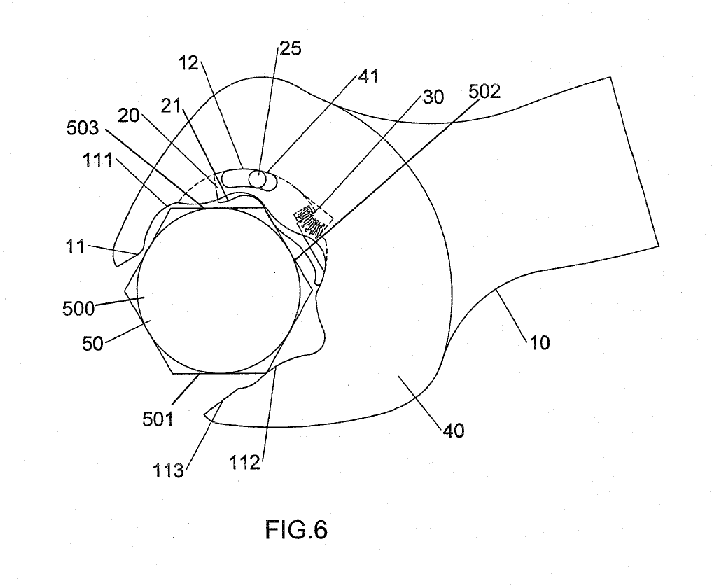

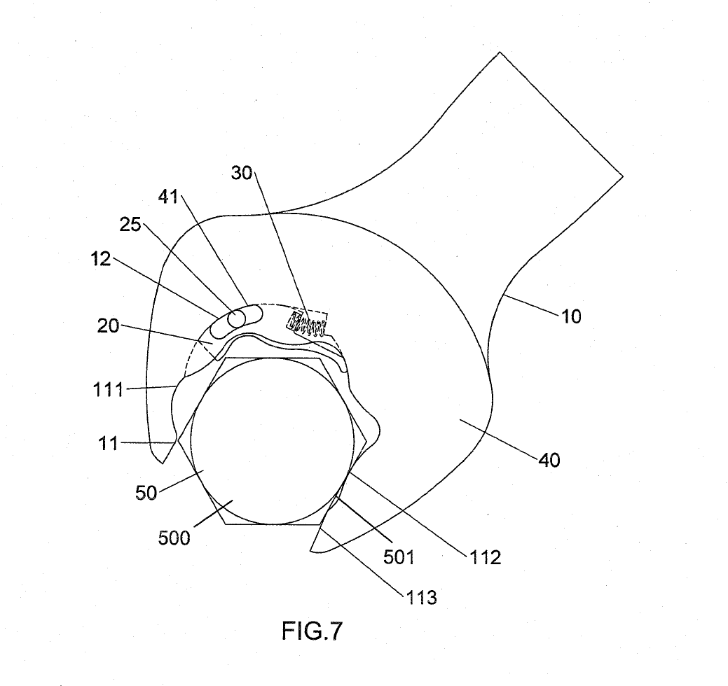

As shown in FIGS. 5 to 7, when the body 10 drives the object 50 to an angle, the body 10 is rotated counter clockwise, because the distance 61 is larger than the distance between two diagonal corners of the hexagonal head 500, the hexagonal head 500 changes the relative position in the mounting hole 11, and the contact face 112 is removed from the side 501 of the hexagonal head 500. The engaging member 20 is pushed by the hexagonal head 500, the two engaging portions 21, 22 are removed from the two sides 502, 503, and the engaging member 20 compresses the resilient member 30 and moves along the curved slot 41 to move away from the axis of the object 50 as shown in FIGS. 5 and 6. The body 10 continuously rotates counter clockwise, to the status as shown in FIG. 7, the mount the object 50 by another angular position, the body 10 can be rotated clockwise to rotate the object 50. This is functioned as a ratchet wrench.

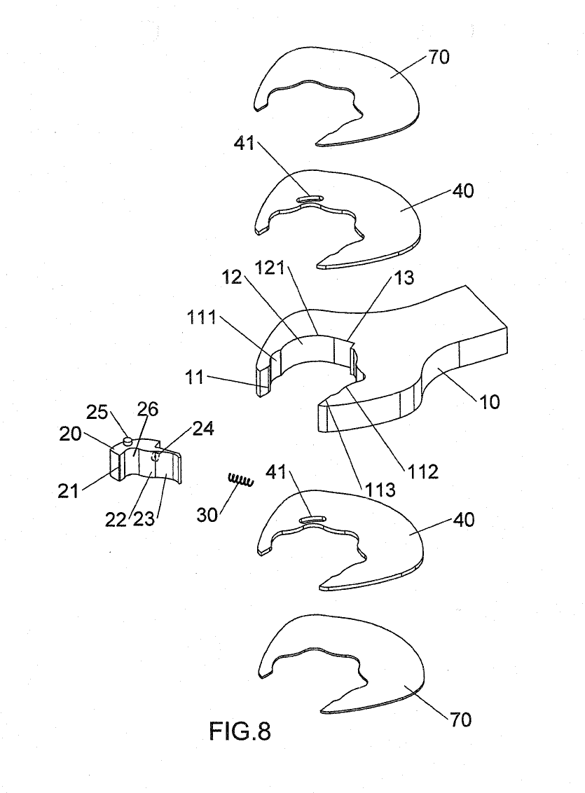

As shown in FIG. 8, which shows the second embodiment, wherein two outer pieces 70 are respectively mounted onto the two covers 40 and the outer pieces 70 have the same shape of the cover 40 so as to cover up the curved slot 41 and the protrusion 25.

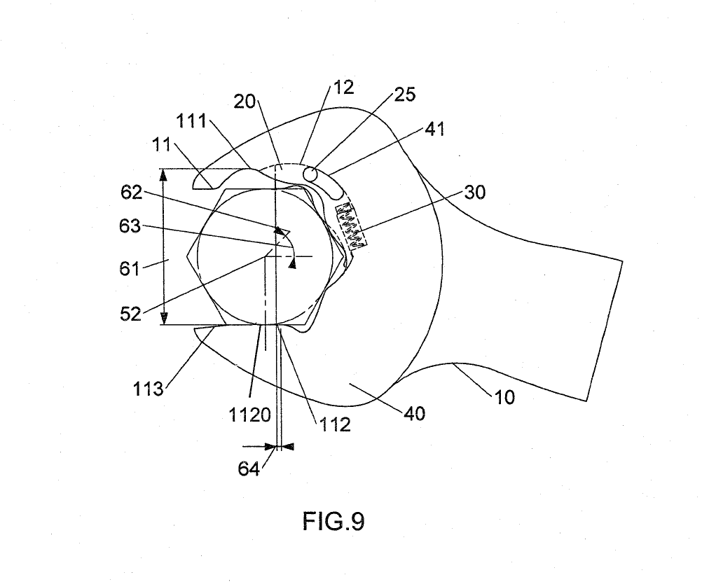

As shown in FIG. 9, which shows the third embodiment, wherein the contact face 112 is a flat surface and has multiple protrusions 1120 formed thereon.

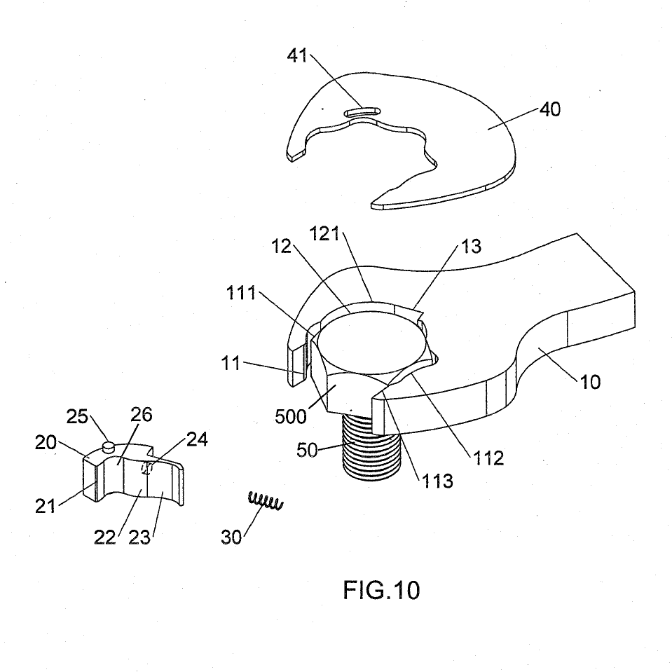

As shown in FIG. 10, which shows the fourth embodiment, wherein only one cover 40 is used to the body 10.

The open wrench of the present invention is functioned as a ratchet wrench and easily manufactured. The present invention is manufactured at low cost and has better strength. The present invention clamps three sides of the hexagonal head to apply sufficient torque to the object. The body 10 and the engaging member 20 have complete structure which has better strength. The engaging member 20 and the contact face 112 clamp the sides 501/502/503 of the hexagonal head 500 of the object 50 and are located close to the center of the object 50 so that sufficient torque can be applied to the object 50. The recessed area of the engaging member 20 accommodates the corner 504 of the hexagonal head 500 to avoid wearing. The diameter of the first curved face 121 is equal to the shortest distance 51 of two opposite sides of the hexagonal head 500 so that the machining is made according the curvature to match the size of the object 50.

While we have shown and described the embodiment in accordance with the present invention, it should be clear to those skilled in the art that further embodiments may be made without departing from the scope of the present invention.

What is claimed is:

1. An open wrench comprising:
an elongate body and a head located on an end of the body, the head having two jaws and a mounting hole defined between the two jaws, an opening defined between two distal ends of the two jaws and communicating with the mounting hole, an axis of the mounting hole being perpendicular to an axis of the body, one of the jaws having a curved recess, a curved guide slot and a notch defined in an inside thereof, the curved recess, the curved guide slot and the notch opening toward a direction of the axis of the mounting hole, the other jaw having a curved convex contact face protruding from an inside thereof, the curved guide slot having a first curved face defined in an inside thereof, the notch having a first side which has a first end connected with and tangential to an end of the first curved face, a second end of the first side being bent to be a second side; the head being cut to have the two jaws with the mounting hole, the curved recess, the contact face, the opening, the curved guide slot and the notch by way of laser cutting or linear cutting;
an engaging member movably received in the curved guide slot and movable along the first curved face, the engaging member having at least one protrusion which is parallel with the axis of the mounting hole, the engaging member having two convex engaging portions; a recessed area is defined at the conjunction area between the two engaging portions;
a resilient member received in the curved guide slot and two ends of the resilient member biased the engaging member and the curved guide slot respectively, and
two covers respectively being welded to connected with the head to cover up the engaging member, each cover having a curved slot which shares a common axis with the first curved face, the at least one protrusion extending through the curved slot; the cover being cut to have the curved slot by way of laser cutting or linear cutting
when a hexagonal head being clamped in the mounting hole, a diameter of the first curved face being equal to or smaller than a shortest distance of two opposite sides of the hexagonal head, the contact face and a flat inside of the opening being in contact with one side of the hexagonal head, the two engaging portions respectively contacting another two opposite sides of the hexagonal head, a corner of the hexagonal head being received in the recessed area between the two engaging portions, a longest distance between the curved recess and the contact face being larger than a distance between two diagonal corners of the hexagonal head, the first curved face being located on a circle and a center of the circle being located within the mounting hole, an angle from 35 to 50 degrees being defined between a shortest distance between the center and the axis of the hexagonal head and the side of the hexagonal head.

2. The open wrench as claimed in claim 1, wherein the engaging member has an end face located corresponding to the second side and the end face has a recess, a restriction portion extends from a side of the end face and is located corresponding to the first side, the end face, the first side, the second side and the restriction portion define a space, the resilient member located in the space and has one end engaged with the recess, the two covers seal the space.

3. The open wrench as claimed in claim 1, wherein the opening is located between two flat insides which extend outwardly to form a gradually enlarged opening.

4. The open wrench as claimed in claim 1, wherein the contact face is a flat surface.

5. The open wrench as claimed in claim 5, wherein the contact face has multiple protrusions.

6. The open wrench as claimed in claim 1, wherein two outer pieces are respectively mounted onto the two covers and the outer pieces have the same shape of the cover so as to cover up the curved slot and the protrusion.

7. The open wrench as claimed in claim 1, wherein the head is formed by way of forge, and then is cut to have the two jaws with the mounting hole, the curved recess, the contact face, the opening, the curved guide slot and the notch by way of laser cutting or linear cutting.
